(19) United States
(12) Patent Application Publication
(10) Pub. No.: US 2016/0170861 A1
(43) Pub. Date: Jun. 16, 2016

(54) Method and a Device Thereof for Achieving the Monitoring Option Script of MySQL Database

(71) Applicant: Xinyu Xingbang Information Industry Co., Ltd, Xinyu (CN)

(72) Inventors: Xiaohong Yao, Foshan (CN); Gong Zhou, Foshan (CN)

(73) Assignee: XINYU XINGBANG INFORMATION INDUSTRY CO., LTD

(21) Appl. No.: 14/709,492

(22) Filed: May 12, 2015

(30) Foreign Application Priority Data
Dec. 16, 2014 (CN) 201410785294.3

(51) Int. Cl. G06F 11/36; G06F 17/30; G06F 9/44

(52) U.S. Cl. CPC G06F 11/3612; G06F 8/31; G06F 17/30303; G06F 17/30371

(57) ABSTRACT

The invention discloses a method for achieving the monitoring option script of MySQL database, comprising the following steps: writing a shell monitoring script; uploading and configuring the shell monitoring script; modifying the execution authority of the shell monitoring script; executing the shell monitoring script; and examining the operation results of the shell monitoring script, and saving or downloading the operation results of the shell monitoring script. The invention further relates to a device for implementing the method for achieving the monitoring option script of MySQL database. The method and the device thereof for achieving the monitoring option script of MySQL database of the invention have the following beneficial effects of: simple and easy installation, easy maintenance and good cross-platform portability and more versions of cross-data database.

### CROSS REFERENCE TO RELATED APPLICATIONS

This application claims priority of Chinese patent application No. 201410785294.3 filed on Dec. 16, 2014, the contents of which all hereby incorporated by reference.

### TECHNICAL FIELD OF THE INVENTION

The invention relates to the field of scripting, in particular to a method and a device thereof for achieving the monitoring option script of MySQL database.

### BACKGROUND OF THE INVENTION

In the prior art, the MySQL GA version is not provided with some common monitoring options to get the results directly. Just as the Percona Toolkit tools, they are powerful but not approachable. Their installation and maintenance are relatively complicated. At present, it is impossible to adopt a single script to realize common monitoring. In addition, most monitoring products are of the source code installation and in Linux version. Their script has poor cross-platform portability. Moreover, each database monitoring has a stable version for test, but few cross-data database versions are available.

### SUMMARY OF THE INVENTION

In order to remedy the current technical defects of complicated installation and maintenance, poor cross-platform portability and few cross-data database versions, the invention provides a method and a device thereof for achieving the monitoring option script of MySQL database featured convenient installation, easy maintenance, good cross-platform portability and more cross-data database versions.

The technical scheme that the invention adopts to solve the technical problems is to construct a method for achieving the monitoring option script of MySQL database, comprising the following steps:

A) Writing a shell monitoring script;

B) Uploading and configuring the shell monitoring script;

C) Modifying the execution authority of the shell monitoring script;

D) Executing the shell monitoring script;

E) Examining the operation results of the shell monitoring script, and saving or downloading the operation results of the shell monitoring script.

According to the method for achieving the monitoring option script of MySQL database of the invention, the step A) further includes:

A1) Setting a global variable and determining whether the global variable is successfully set, and if so, executing step A2); otherwise, executing step A20);

A2) Calling the main function;

A3) Determining whether MySQL database is properly started, and if so, entering MySQL process monitoring and executing step A5); otherwise, executing step A4);

A4) Checking the error log of MySQL database and executing step A20);

A5) Detecting whether the MySQL Server is properly running, and if so, acquiring the current state value of the MySQL database, and executing step A6); otherwise, returning to step A4);

A6) Acquiring the current connection information or the number of connections of the MySQL database;

A7) Displaying the running time of the MySQL database;

A8) Examining the memory size of MySQL database and the size of the MySQL database;

A9) Examining the size of the first 20 tables and the first 20 indexes of the MySQL database;

A10) Examining the column information of a certain table;

A11) Examining the common state value and the common global variable of the MySQL database and calling the sql script;

A12) Sequentially querying MySQL QPS and MySQL Key Buffer hit rate, MySQL Innodb Buffer hit rate, MySQL Query Cache hit rate, MySQL Table Cache state variable, MySQL Thread Cache hit rate and MySQL Query lock state;

A13) Checking whether the MySQL Server is a master-slave architecture or whether the Percona is a multi-master architecture, and if so, examining multi-master basic information and executing step A14), otherwise, examining the master-slave basic information and executing step A14);

A14) Successively examining the state of MySQL Tmp table, the usage of MySQL Binlog Cache and the amount of MySQL InnoDB log waits;

A15) Performing long query of MySQL database;

A16) Checking the utilities;

A17) Interpreting MySQL case functions;

A18) Searching MySQL configuration parameter file functions;

A19) Formatting output configuration parameter file functions;

A20) Completing shell monitoring script writing.

According to the method for achieving the monitoring option script of MySQL database of the invention, the step B) is to upload the shell monitoring script to the running directory.

According to the method for achieving the monitoring option script of MySQL database of the invention, the database includes a production library and the step D) includes the step of manually executing the shell monitoring script according to the requirements of the production library at any time to examine the current state of the MySQL database or timely performing the shell monitoring script.

The invention further relates to a device for implementing the method for achieving the monitoring option script of MySQL database, comprising:

A writing unit: for writing shell monitoring script;

A script uploading unit: for uploading and configuring the shell monitoring script;

An authority modifying unit: for modifying the execution authority of the shell monitoring script;

A script executing unit: for executing the shell monitoring script;

A script operating unit: for examining the operation results of the shell monitoring script, and saving or downloading the operation results of the shell monitoring script.

According to the device for implementing the method for achieving the monitoring option script of MySQL database of the invention, the writing unit further includes:

A variable setting module: for setting the global variable and determining whether the global variable is successfully set;

A calling module: for calling the main function;

A starting module: for determining whether MySQL database is properly started, and if so, entering MySQL process monitoring; otherwise, checking the database error log;

A log inspecting module: for checking the database error log;

A detecting module: for detecting whether the MySQL Server is properly running, and if so, acquiring the current state value of the MySQL database; otherwise, returning;

An acquiring module: for acquiring the current connection information or the number of connections of the MySQL database;

A displaying module: for displaying the running time of the MySQL database;

A memory examining module: for examining the memory size of MySQL database and the size of the MySQL database;

A database examining module: for examining the size of the first 20 tables and the first 20 indexes of the MySQL database;

A column information examining module: for examining the column information of a certain table;

A script calling module: for examining the common state value and the common global variable of the MySQL database and calling the sql script;

A query module: for sequentially examining MySQL QPS and MySQL Key Buffer hit rate, MySQL Innodb Buffer hit rate, MySQL Query Cache hit rate, MySQL Table Cache state variable, MySQL Thread Cache hit rate and MySQL Query lock state;

An architecture inspecting module: for checking whether the MySQL Server is a master-slave architecture or whether the Percona is a multi-master architecture, and if so, examining multi-master basic information; otherwise, examining the master-slave basic information;

A usage examining module: for successively examining the state of MySQL Tmp table, the usage of MySQL Binlog Cache and the amount of MySQL InnoDB log waits;

A long query module: for long query of MySQL database;

A program checking module: for checking the utilities;

A case function interpreting module: for interpreting MySQL case function;

A function searching module: for searching MySQL configuration parameter file functions;

A formatting module: for formatting output configuration parameter file functions;

A completing module: for completing shell monitoring script writing.

According to the device for implementing the method for achieving the monitoring option script of MySQL database of the invention, the calling module is to upload the shell monitoring script to the running directory.

According to the device for implementing the method for achieving the monitoring option script of MySQL database of the invention, the script executing unit includes the step of manually executing the shell monitoring script according to the requirements of the production library at any time to examine the current state of the MySQL database or timely performing the shell monitoring script.

The method and the device thereof for achieving the monitoring option script of MySQL database of the invention include the following steps: writing a shell monitoring script; uploading and configuring the shell monitoring script; modifying the execution authority of the shell monitoring script; executing the shell monitoring script; and saving or downloading the operation results of the shell monitoring script. The invention has the following beneficial effects of: simple and easy installation, easy maintenance and good cross-platform portability and more versions of cross-data database.

### BRIEF DESCRIPTION OF DRAWINGS

In order to clearly illustrate the technical schemes of the embodiments of the invention or the prior art, the drawings of the embodiments or the prior art will be briefly described in the following. It is obvious that the following drawings are only for some embodiments of the invention. Without creative efforts, those skilled in the art can also obtain more other drawings according to such drawings.

FIG. 1 is a flow chart of one embodiment of the method and the device thereof for achieving the monitoring option script of MySQL database of the invention

FIG. 2 is a specific flow chart of writing shell monitoring script of the embodiment;

FIG. 3 is a structural diagram of the device of the embodiment;

FIG. 4 is a structural diagram of the writing unit of the embodiment;

### DETAILED DESCRIPTION OF THE EMBODIMENTS

The technical schemes of the embodiments of the invention will be described clearly and completely in conjunction with the attached drawings of the embodiments. It is obvious that the described embodiments are merely a part but not all of the embodiments of the invention. Based on the embodiments of the invention, all other embodiments obtained without creative efforts by those skilled in the art shall be within the protection scope of the invention.

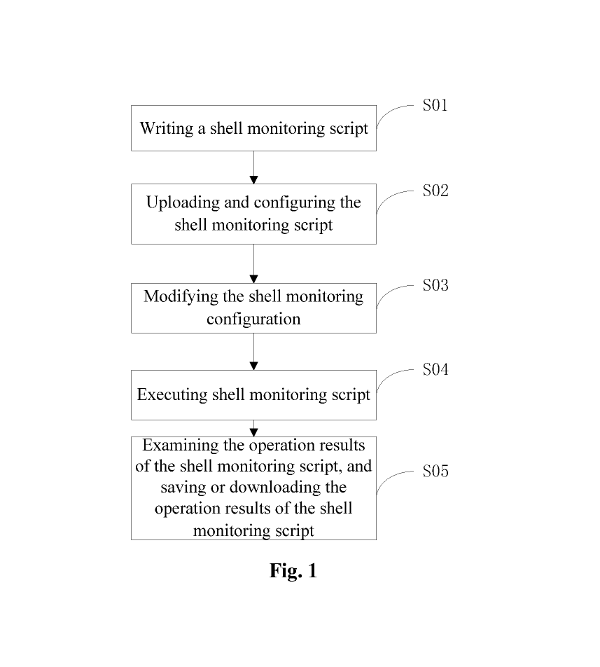

In the embodiment of the method and the device thereof for achieving the monitoring option script of MySQL database of the invention, the flow chart of the method for achieving the monitoring option script of MySQL database is as shown in FIG. 1. In FIG. 1, the method for achieving the monitoring option script of MySQL database includes the following steps:

Step S01: writing shell monitoring scripts. In this step, the shell monitoring script is written.

Step S02: uploading and configuring the shell monitoring script. In this step, the shell monitoring script is uploaded to in the running directory and configured the monitoring script.

Step S03: modifying the execution authority of the shell monitoring script. In this step, the execution authority of the shell monitoring script is modified.

Step S04: executing the shell monitoring script. In this step, the monitoring shell script is executed. It includes manually executing the shell monitoring script according to the requirements of the production library at any time to examine the current state of the MySQL database or crontab timing execution of the shell monitoring script. For example, it is executed every three hours from 9 am to 21:00 pm. in each day of every month. The specific frequency is set accordingly depending on the circumstances. It has a better controlling nature by either manually executing the generation results or automatically executing them through adding to the operating system. Further, it can be integrated into such current popular monitoring software as nagios, cacti, and etc.

Step S05: examining the operation results of the shell monitoring script, and saving or downloading the operation results of the shell monitoring script. This step is to examine the operating results of the shell monitoring script. When the MySQL data monitoring contents are not to understand, the operating results of the shell monitoring script can be saved to another disk or downloaded to a more professional person, such as a DBA diagnosis personnel. It has such beneficial effects as simple and easy installation, easy maintenance, and good applicability to people without experiences. Moreover, it has a good cross-platform portability, which can be run on most Linux/Unix operating systems. Furthermore, more cross-data database versions are available with applicable MySQL versions from 5.x to 6.x.

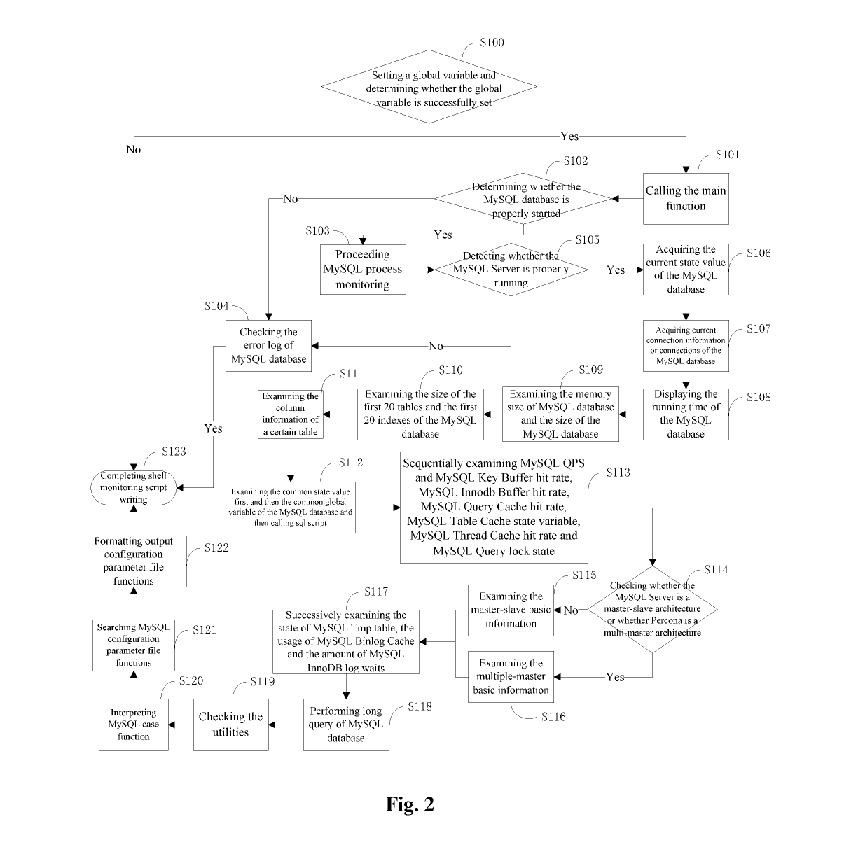

According to this embodiment, the step S01 may be further refined, and the refined flow chart is shown in FIG. 2. In FIG. 2, the step S01 further comprises:

Step S100: setting a global variable and determining whether the global variable is successfully set. In this step, the global variable is set and determined whether it is successfully set, if so, executing step S101; otherwise, executing step S123;

Step S101: calling the main function: If the judging result of the above step S100 is positive, executing this step. In this step, the main function is called. After this step, executing step S102.

Step S102: determining whether the MySQL database is properly started. In this step, the MySQL database is determined whether it is properly started, if so, executing step S103; otherwise, executing step S104.

Step S103: proceeding MySQL process monitoring: If the judging result of the above step S102 is positive, executing this step of MySQL process monitoring. After this step, executing step S105.

Step S104: checking the error log of MySQL database: If the judging result of the step S102 is negative, executing this step. In this step, the error log of MySQL database is checked. After this step, executing step S123.

Step S105: detecting whether the MySQL Server is properly running. In this step, the MySQL Server is detected whether it is properly running, if so, executing step S106; otherwise, returning to step S104.

Step S106: acquiring the current state value of the MySQL database. If the judgment result of above step S105 is positive, executing this step. In this step, the current state value of the MySQL database is acquired.

Step S107: acquiring the current connection information or the number of connections of the MySQL database. In this step, the current connection information or the number of connections of the MySQL database is acquired.

Step S108: displaying the running time of the MySQL database. In this step, the running time of the MySQL database is displayed.

Step S109: examining the memory size of MySQL database and the size of the MySQL database. In this step, the memory size of MySQL database and the size of the MySQL database are examined.

Step S110: examining the size of the first 20 tables and the first 20 indexes of the MySQL database. In this step, the size of the first 20 tables and the first 20 indexes of the MySQL database are examined. Of course, in some cases of the embodiment, the size of the first several tables and indexes in MySQL database can also be examined.

Step S111: examining the column information of a certain table. In this step, the column information of a certain table is examined.

Step S112: examining the common state value and the common global variable of the MySQL database and then calling the sql script. In this step, the common state value of the MySQL database is examined first, and the common global variable of the MySQL database is examined then. Further, the sql script is called.

Step S113: sequentially querying MySQL QPS and MySQL Key Buffer hit rate, MySQL Innodb Buffer hit rate, MySQL Query Cache hit rate, MySQL Table Cache state variable, MySQL Thread Cache hit rate and MySQL Query lock state. In this step, such elements are queried as MySQL QPS and MySQL Key Buffer hit rate, MySQL Innodb Buffer hit rate, MySQL Query Cache hit rate, MySQL Table Cache state variable, MySQL Thread Cache hit rate and MySQL Query lock state. It is worth mentioning that in this embodiment, MySQL Thread Cache hit rate of above 90% is relatively reasonable. The locked state of MySQL can be queried by obtaining the total times of locking through the system state variables. In case of waiting of other threads caused by locking, executing step S114.

Step S114: checking whether the MySQL Server is a master-slave architecture or whether the Percona is a multi-master architecture. In this step, it is checked whether the MySQL Server is a master-slave architecture or whether the Percona is a multi-master architecture. If the judging result is positive, executing step S116; otherwise, executing step S115.

Step S115: examining the master-slave basic information: If the judging result of the above steps S114 is negative, executing this step. After this step, executing step S117.

Step S116: examining the multiple-master basic information: If the judging result of the above steps S114 is positive, executing this step. After this step, executing step S117.

Step S117: successively examining the state of MySQL Tmp table, the usage of MySQL Binlog Cache and the amount of MySQL InnoDB log waits. In this step, such elements are successively examined as the state of My SQL Tmp table, the usage of MySQL Binlog Cache and the amount of MySQL InnoDB log waits.

Step S118: performing long query of MySQL database. In this step, the long query of MySQL database is performed.

Step S119: checking the utilities. In this step, such utilities are checked as mysqlcheck utilities and the like.

Step S120: interpreting MySQL case function. In this step, MySQL case function is interpreted.

Step S121: searching MySQL configuration parameter file functions. In this step, MySQL configuration parameter file functions are searched.

Step S122: formatting output configuration parameter file functions. In this step, the output configuration parameter file functions are formatted.

Step S123: completing shell monitoring script writing. In this step, the shell monitoring script writing is completed. According to this embodiment, the MySQL monitoring generates a log file in the same directory for each running for easy access and transmission. There are more than 20 items of log file monitoring contents, such as MySQL process monitoring, detecting whether MySQL Server provides service properly, acquiring several current state values of the MySQL database, acquiring current connection information of the MySQL database, examining the allocated total memory size of the MySQL database, examining the MySQL database size, examining the size of the first 20 tables of MySQL database, examining the common global variables of current MySQL database, MySQL QPS query, innodb_buffer_read_hits, MySQL Query Cache hit rate, MySQL Table Cache state amount, checking whether MySQL Sever is a master-slave architecture or whether the Percona is a multi-master architecture, the amount of MySQL nnodb_log_waits, checking and repairing the mysqlcheck utilities and the like. It is worth mentioning that the MySQL monitor contents can also be added automatically according to the format to enrich the actual needs, which has a strong flexibility.

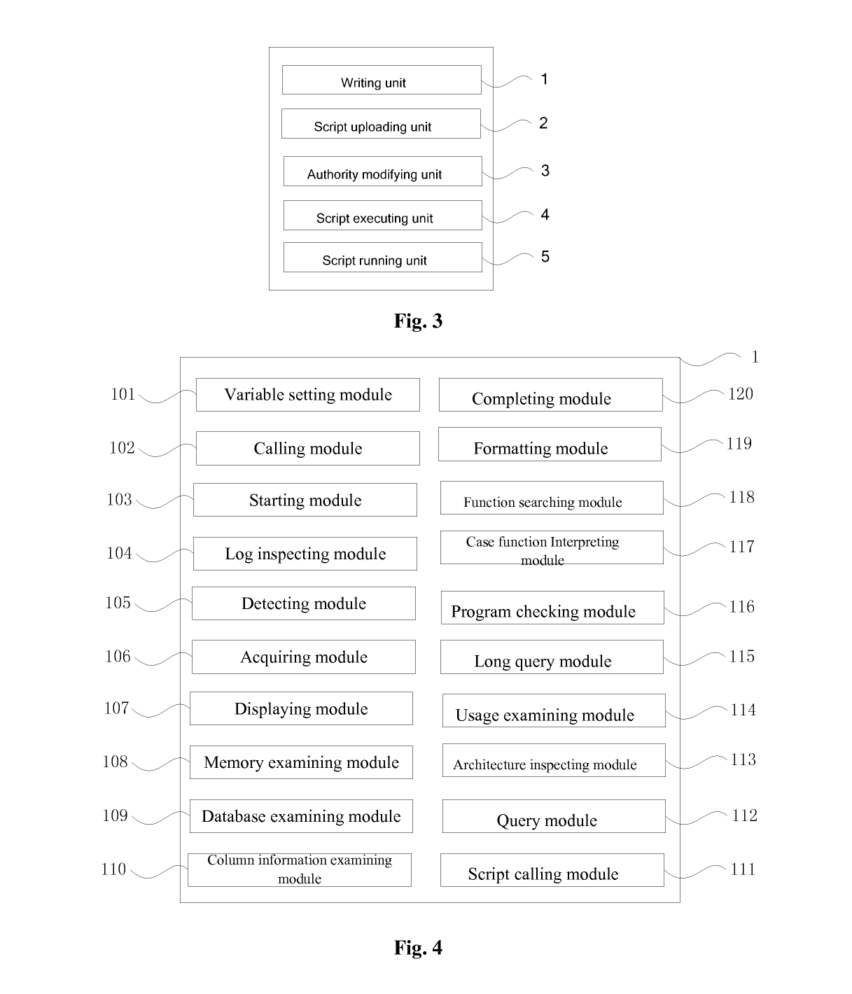

The present embodiment further relates to a device for implementing the method for achieving the monitoring option script of MySQL database, wherein, the structural diagram is as shown in FIG. 3. In FIG. 3, the device comprises a writing unit 1 for writing a shell monitoring script, a script uploading unit 2 for uploading and configuring the shell monitoring script, an authority modifying unit 3 for modifying the execution authority of the shell monitoring script, a script executing unit 4 for executing the shell monitoring script and a script operating unit 5 for examining the operation results of the shell monitoring script, and saving or downloading the operation results of the shell monitoring script. It has such beneficial effects as simple and easy installation, easy maintenance, and good applicability to people without experiences. Moreover, it has a good cross-platform portability, which can be run on most Linux/Unix operating systems. Furthermore, more cross-data database versions are available with applicable MySQL versions from 5.x to 6.x.

According to this embodiment, the writing unit 1 can further be refined, and the refined structural diagram is shown in FIG. 4. In FIG. 4, the writing unit 1 further comprises a variable setting module 101, a calling module 102, a starting module 103, a log inspecting module 104, a detecting module 105, an acquiring module 106, a displaying module 107, a memory examining module 108, a database examining module 109, a column information examining module 110, a script calling module 111, a query module 112, an architecture inspecting module 113, a usage examining module 114, a long query module 115, a program checking module 116, a case function interpreting module 117, a function searching module 118, a formatting module 119 and a completing module 120; wherein, the variable setting module 101 is used for setting the global variable and determining whether the global variable is successfully set; the calling module 102 is used for calling the main function; the starting module 103 is used for determining whether MySQL database is properly started, and if so, proceeding MySQL process monitoring; otherwise, checking the database error log; the log inspecting module 104 is used for checking the database error log; the detecting module 105 is used for detecting whether the MySQL Server is properly running, and if so, acquiring the current state value of the MySQL database; otherwise, returning; the acquiring module 106 is used for acquiring the current connection information or the number of connections of the MySQL database; the displaying module 107 is used for displaying the running time of the MySQL database; the memory examining module 108 is used for examining the memory size of MySQL database and the size of the MySQL database; the database examining module 109 is used for examining the size of the first 20 tables and the first 20 indexes of the MySQL database; the column information examining module 110 is used for examining the column information of a certain table; the script calling module 111 is used for examining the common state value and the common global variable of the MySQL database and calling the sql script; the query module 112 is used for sequentially examining MySQL QPS and MySQL Key Buffer hit rate, MySQL Innodb Buffer hit rate, MySQL Query Cache hit rate, MySQL Table Cache state variable, MySQL Thread Cache hit rate and MySQL Query lock state; the architecture inspecting module 113 is used for checking whether the MySQL Server is a master-slave architecture or whether the Percona is a multi-master architecture, and if so, examining multi-master basic information; otherwise, examining the master-slave basic information; the usage examining module 114 is used for successively examining the state of MySQL Tmp table, the usage of MySQL Binlog Cache and the amount of MySQL InnoDB log waits; the long query module 115 is used for long query of MySQL database; the program checking module 116 is used for checking the utilities; the case interpreting module 117 is used for interpreting MySQL case function; the function searching module 118 is used for searching MySQL configuration parameter file functions; the formatting module 119 is used for formatting output configuration parameter file functions; and the completing module 120 is used for completing shell monitoring script writing.

According to this embodiment, the calling module 102 is to upload the shell monitoring script to the running directory. In the script executing unit 4, it includes the step of manually executing the shell monitoring script according to the requirements of the production library at any time to examine the current state of the MySQL database or timely performing the shell monitoring script.

In conclusion, the code performance in this embodiment is relatively poor due to imperfection of the existing shell script logics, therefore, more specialized MySQL monitoring contents should be referred to and the monitoring of some resource utilization of the operating system should be added. In the prior art, it can neither be integrated in the same log file nor generate a log simultaneously, which is inconvenient for access and transmission. However, in the present embodiment, the MySQL monitoring logs are subject to centralized management. And each operation will be generated with a log file in the same directory, which is easy for access and transmission. It has a good cross-platform portability and more versions of cross-data database. It can be executed manually or automatically. Since the monitoring logs are concentrated, it involves only the protocol or the compatibility of format and can achieve the purpose without specific technical improvements. In this embodiment, the common monitoring contents of the MySQL database on the minicomputers can be realized automatically and a number of monitoring contents can be written on a same log file and listed in an ascending order of time.

The foregoing embodiments are merely exemplary embodiments of the invention, and not intended to define the scope of the invention, and any modification, equivalent replacement, improvement and the like within the spirits and the principles of the invention shall be included within the protection scope of the invention.

What is claimed is:

1. A method for achieving the monitoring option script of MySQL database, wherein, includes the following steps:
A) Writing a shell monitoring script;
B) Uploading and configuring the shell monitoring script;
C) Modifying the execution authority of the shell monitoring script;
D) Executing the shell monitoring script;
E) Examining the operation results of the shell monitoring script, and saving or downloading the operation results of the shell monitoring script.

2. The method for achieving the monitoring option script of MySQL database according to claim 1, wherein, the step A) further includes the following steps:
A1) Setting a global variable and determining whether the global variable is successfully set, and if so, executing step A2); otherwise, executing step A20);
A2) Calling the main function;
A3) Determining whether MySQL database is properly started, and if so, entering MySQL process monitoring and executing step A5); otherwise, executing step A4);
A4) Checking the error log of MySQL database and executing step A20);
A5) Detecting whether the MySQL Server is properly running, and if so, acquiring the current state value of the MySQL database, and executing step A6); otherwise, returning to step A4);
A6) Acquiring the current connection information or the number of connections of the MySQL database;
A7) Displaying the running time of the MySQL database;
A8) Examining the memory size of MySQL database and the size of the MySQL database;
A9) Examining the size of the first 20 tables and the size of the first 20 indexes of the MySQL database;
A10) Examining the column information of a certain table;
A11) Examining the common state value and the common global variable of the MySQL database and calling the sql script;
A12) Sequentially examining MySQL QPS and MySQL Key Buffer hit rate, MySQL Innodb Buffer hit rate, MySQL Query Cache hit rate, MySQL Table Cache state variable, MySQL Thread Cache hit rate and MySQL Query lock state;
A13) Checking whether the MySQL Server is a master-slave architecture or whether the Percona is a multi-master architecture, and if so, examining multi-master basic information and executing step A14), otherwise, examining the master-slave basic information and executing step A14);
A14) Successively examining the state of MySQL Tmp table, the usage of MySQL Binlog Cache and the amount of MySQL InnoDB log waits;
A15) Executing the long query of MySQL database;
A16) Checking the utilities;
A17) Interpreting MySQL case function;
A18) Searching MySQL configuration parameter file functions;
A19) Formatting output configuration parameter file functions;
A20) Completing monitoring script writing.

3. The method for achieving the monitoring option script of MySQL database according to claim 1, wherein, the step B) is to upload the shell monitoring script to the running directory.

4. The method for achieving the monitoring option script of MySQL database according to claim 2, wherein, the step B) is to upload the shell monitoring script to the running directory.

5. The method for achieving the monitoring option script of MySQL database according to claim 3, wherein, the database includes a production library and the step D) includes the step of manually executing the shell monitoring script according to the requirements of the production library at any time to examine the current state of the MySQL database or timely performing the shell monitoring script.

6. The method for achieving the monitoring option script of MySQL database according to claim 4, wherein, the database includes a production library and the step D) includes the step of manually executing the shell monitoring script according to the requirements of the production library at any time to examine the current state of the MySQL database or timely performing the shell monitoring script.

7. A device for implementing the method for achieving the monitoring option script of MySQL database according to claim 1, wherein, the said device comprises:
A writing unit: for writing the shell monitoring script;
A script uploading unit: for uploading and configuring the shell monitoring script;
An authority modifying unit: for modifying the execution authority of the shell monitoring script;
A script executing unit: for executing the shell monitoring script;
A script operating unit: for examining the operation results of the shell monitoring script, and saving or downloading the operation results of the shell monitoring script.

8. The device for implementing the method for achieving the monitoring option script of MySQL database according to claim 7, wherein, the writing unit further comprises:
A variable setting module: for setting the global variable and determining whether the global variable is successfully set;
A calling module: for calling the main function;
A starting module: for determining whether MySQL database is properly started, and if so, entering MySQL process monitoring; otherwise, checking the database error log;
A log inspecting module: for checking the database error log;
A detecting module: for detecting whether the MySQL Server is properly running, and if so, acquiring the current state value of the MySQL database; otherwise, returning;
An acquiring module: for acquiring the current connection information or the number of connections of the MySQL database;
A displaying module: for displaying the running time of the MySQL database;
A memory examining module: for examining the memory size of MySQL database and the size of the MySQL database;
A database examining module: for examining the size of the first 20 tables and the first 20 indexes of the MySQL database;
A column information viewing module: for examining the column information of a certain table;
A script calling module: for examining the common state value and the common global variable of the MySQL database and calling the sql script;
A query module: for sequentially examining MySQL QPS and MySQL Key Buffer hit rate, MySQL Innodb Buffer hit rate, MySQL Query Cache hit rate, MySQL Table Cache state variable, MySQL Thread Cache hit rate and MySQL Query lock state;
An architecture inspecting module: for checking whether the MySQL Server is master-slave architecture or whether the Percona is a multi-master architecture, and if so, examining multi-master basic information; otherwise, examining the master-slave basic information;
A usage examining module: for successively examining the state of MySQL Tmp table, the usage of MySQL Binlog Cache and the amount of MySQL InnoDB log waits;
A long query module: for long query of MySQL database;
A program checking module: for checking the utilities;
A case function interpreting module: for interpreting MySQL case function;
A function searching module: for searching MySQL configuration parameter file functions;
A formatting module: for formatting output configuration parameter file functions;
A completing module: for completing shell monitoring script writing.

9. The device for implementing the method for achieving the monitoring option script of MySQL database according to claim 7, wherein, the calling module is to upload the shell monitoring script to the running directory.

10. The device for implementing the method for achieving the monitoring option script of MySQL database according to claim 8, wherein, the calling module is to upload the shell monitoring script to the running directory.

11. The device for implementing the method for achieving the monitoring option script of the MySQL database according to claim 9, wherein, the script executing unit includes the step of manually executing the shell monitoring script according to the requirements of the production library at any time to examine the current state of the MySQL database or timely performing the shell monitoring script.

12. The device for implementing the method for achieving the monitoring option script of the MySQL database according to claim 10, wherein, the script executing unit includes the step of manually executing the shell monitoring script according to the requirements of the production library at any time to examine the current state of the MySQL database or timely performing the shell monitoring script.
